(19) United States
(12) Patent Application Publication
(10) Pub. No.: US 2009/0240852 A1
(43) Pub. Date: Sep. 24, 2009

(54) UART/USB CONVERTING APPARATUS

(75) Inventor: Yun-Song Gou, Richmond (CA)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ATEN INTERNATIONAL CO., LTD., Taipei County (TW)

(21) Appl. No.: 12/051,980

(22) Filed: Mar. 20, 2008

(51) Int. Cl. G06F 13/12

(52) U.S. Cl. 710/63

(57) ABSTRACT

A UART/USB converting apparatus includes a UART connector, a UART/USB converting chip and a USB connector. The UART connector is for transceiving a UART signal ranging from 0 to 3.3 volts. The UART/USB converting chip electrically connected to the UART connector is for converting between the UART signal and a USB signal. The USB connector electrically connected to the UART/USB converting chip is for transmitting the USB signal.

### BACKGROUND OF THE INVENTION

1. Field of the Invention

The invention relates in general to a converting apparatus, and more particularly to a UART/USB converting apparatus.

2. Description of the Related Art

RS-232 (Recommended Standard-232) is a non-synchronous transmission standard interface specified by the EIA (Electronic Industries Association), and is also a transmission interface between some electronic apparatuses and a computer. Because the RS-232 can be easily set and has the low error rate, many manufacturers use the RS-232 to detect products, to update the software in the electronic apparatus or to create the remote connection.

FIG. 1 (Prior Art) is a schematic illustration showing an RS232 signal transmission cable 10. FIG. 2 (Prior Art) is a schematic illustration showing an electronic apparatus and a computer. Referring to FIGS. 1 and 2, the RS232 signal transmission cable 10 includes an RS232 connector 110, an RS232 cable 120 and an RS232 connector 130, wherein two ends of the RS232 cable 120 are respectively coupled to the RS232 connector 110 and the RS232 connector 130.

When the RS232 connector 110 is coupled to an RS232 connector 230 of an electronic apparatus 20 and the RS232 connector 130 is coupled to an RS232 connector 310 of a computer 30, the electronic apparatus 20 is electrically connected to the computer 30. The electronic apparatus 20 and the computer 30 transmit an RS232 signal S2 via the RS232 signal transmission cable 10.

The RS232 signal S2 satisfying the RS232 specification has a voltage level equal to +15 volts or −15 volts, but a CPU 210 in the electronic apparatus 20 outputs a signal S1 having a voltage level ranging from 0 to 3.3 volts. In order to solve this problem, each electronic apparatus 20 must include an RS232 voltage converting chip 220 electrically connected between the CPU 210 and the RS232 connector 230. The RS232 voltage converting chip 220 is for converting a voltage between the signal S1 and the RS232 signal S2 so that the signal S1 with 0 to 3.3 volts can be converted into the RS232 signal S2 with +15 volts or −15 volts, and then outputted to the computer 30 through the RS232 signal transmission cable 10.

However, the RS232 voltage converting chip 220, such as max232, is disposed in each electronic apparatus 20. The difficulty of circuit layout on a circuit board is increased, and the manufacturing cost is increased, thereby influencing the product competitiveness. In addition, most notebook computers except the computer 30 do not have an RS232 connection port. Consequently, the RS232 signal S2 cannot be transmitted between the electronic apparatus 20 and the notebook computer through the RS232 signal transmission cable 10.

### SUMMARY OF THE INVENTION

The invention is directed to a UART/USB converting apparatus for transceiving a UART signal ranging from 0 to 3.3 volts but not an RS232 signal with +15 volts or −15 volts so that an RS232 voltage converting chip does not have to be additionally provided in an electronic apparatus. Consequently, the manufacturing cost can be greatly decreased, and the difficulty of circuit layout is also decreased. Furthermore, when the computer is either a desktop computer or a notebook computer, the electronic apparatus still can communicate with the computer through the UART/USB converting apparatus.

According to a first aspect of the present invention, a UART/USB converting apparatus is provided. The UART/USB converting apparatus includes a UART connector, a UART/USB converting chip and a USB connector. The UART connector is for transceiving a UART signal ranging from 0 to 3.3 volts. The UART/USB converting chip electrically connected to the UART connector is for converting between the UART signal and a USB signal. The USB connector electrically connected to the UART/USB converting chip transmits the USB signal.

According to a second aspect of the present invention, a UART/USB converting apparatus is provided. The UART/USB converting apparatus includes a first adapter and a second adapter.

The first adapter includes a UART connector and a first connector. The UART connector is for transceiving a UART signal ranging from 0 to 3.3 volts, and the first connector is electrically connected to the UART connector.

The second adapter includes a second connector, a UART/USB converting chip and a USB connector. The second connector is to be electrically connected to the first connector. The UART/USB converting chip electrically connected to the second connector is for converting between the UART signal and a USB signal. The USB connector electrically connected to the UART/USB converting chip is for transceiving the USB signal.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a schematic illustration showing an RS232 signal transmission cable.

FIG. 2 (Prior Art) is a schematic illustration showing an electronic apparatus and a computer.

FIG. 3 is a schematic illustration showing an electronic apparatus communicating with a computer through a UART/USB converting apparatus.

FIG. 4 is a block diagram showing a UART/USB converting apparatus according to a first embodiment of the invention.

FIG. 5 is a schematic illustration showing a UART/USB converting chip 620 and a USB connector 630, which are disposed on a circuit board 640.

FIG. 6 is a schematic illustration showing a UART connector 610, the UART/USB converting chip 620 and the USB connector 630, all of which are disposed on the circuit board 640a.

FIG. 7 is a block diagram showing a UART/USB converting apparatus according to a second embodiment of the invention.

FIG. 8 is a schematic illustration showing a UART connector 712 and a connector 714 coupled together through a cable 716.

FIG. 9 is a schematic illustration showing the UART connector 712 and the connector 714, which are disposed on a circuit board 718.

FIG. 10 is a schematic illustration showing a UART/USB converting chip 724 and a USB connector 726 disposed on a circuit board 728.

FIG. 11 is a schematic illustration showing a connector 722, a UART/USB converting chip 724 and a USB connector 726 disposed on a circuit board 728a.

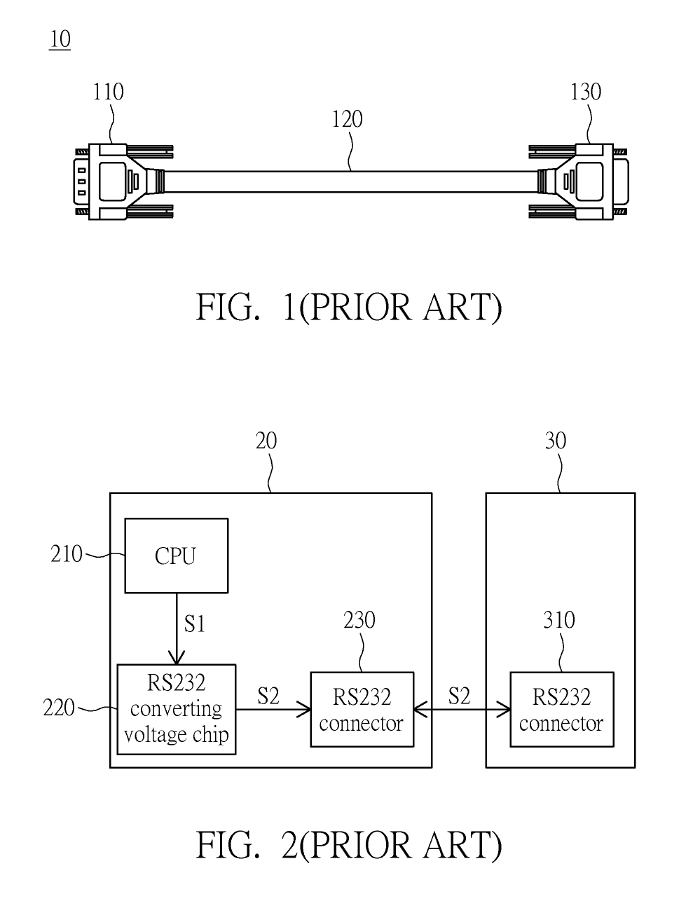

### DETAILED DESCRIPTION OF THE INVENTION

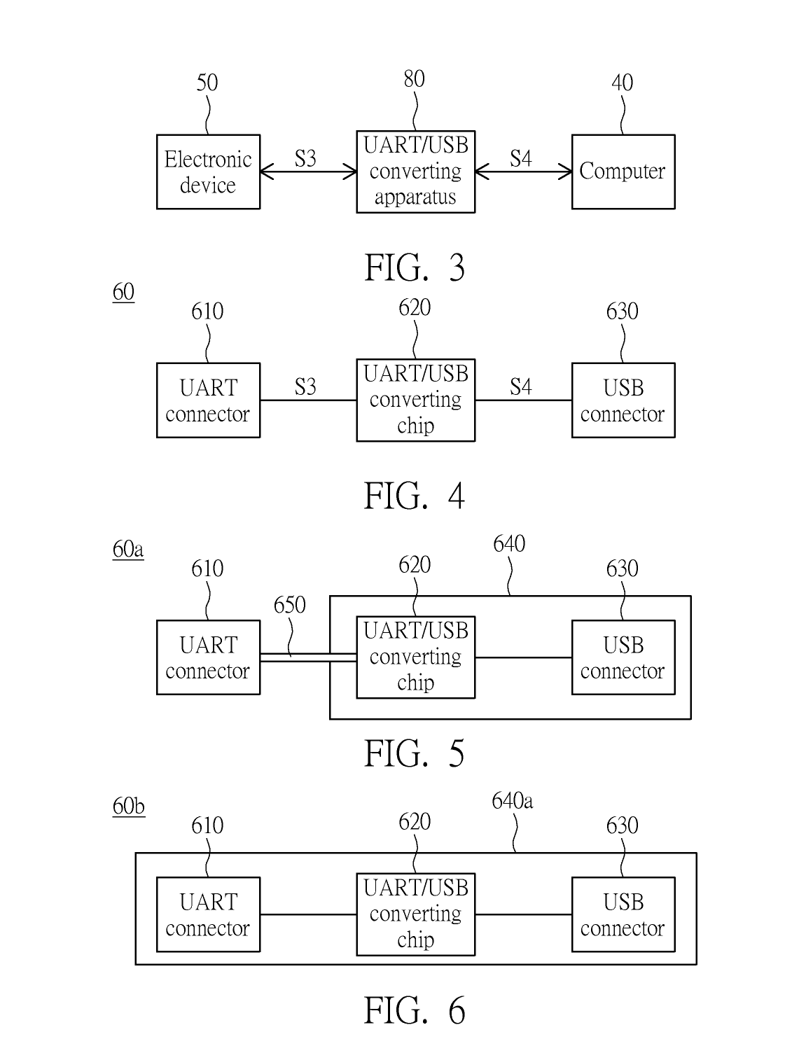

FIG. 3 is a schematic illustration showing an electronic apparatus communicating with a computer through a universal asynchronous receiver/transmitter (UART)/universal serial bus (USB) converting apparatus 80. As shown in FIG. 3, the UART/USB converting apparatus 80 is for converting between a UART signal S3 ranging from 0 to 3.3 volts and a USB signal S4 so that an electronic apparatus 50 communicates with a computer 40 through the UART/USB converting apparatus 80.

Thus, no RS232 voltage converting chip has to be additionally disposed in the electronic apparatus 50 so that the manufacturing cost is greatly decreased and the difficult of circuit layout is also decreased. In addition, each of the current desktop computer and the current notebook computer has a USB connection port. Thus, the electronic apparatus 50 can communicate with the computer 40, which is either the desktop computer or the notebook computer, through the UART/USB converting apparatus.

In order to specify the contents of the invention in detail, the first and second embodiments will be described in the following. However, the invention is not limited thereto. One of ordinary skill in the art may easily understand that the invention is intended to cover various modifications and similar arrangements and procedures, and the scope of the appended claims therefore should be accorded the broadest interpretation so as to encompass all such modifications and similar arrangements and procedures.

### First Embodiment

FIG. 4 is a block diagram showing the UART/USB converting apparatus according to the first embodiment of the invention. The UART/USB converting apparatus 80 is represented by a UART/USB converting apparatus 60 in the first embodiment. The UART/USB converting apparatus 60 includes a UART connector 610, a UART/USB converting chip 620 and a USB connector 630. The UART connector 510 is electrically connected to a UART connector in the electronic device 50. The USB connector 630 is electrically connected to a USB connector in the computer 40. The UART/USB converting chip 620 is electrically connected between the UART connector 610 and the USB connector 630. The UART/USB converting chip 620 may be PL2303, PV8651, ft232bm, cp2101 and the like converting chip.

The UART connector 610 is for transceiving the UART signal S3 ranging from 0 to 3.3 volts. The UART connector 610 may be, for example, a DB9 connector or a RJ-11 connector, while the UART signal S3 preferably ranges from 0 to 3.3 volts.

The UART/USB converting chip 620 electrically connected to the UART connector 610 is for converting between the UART signal S3 and the USB signal S4. The USB connector 630 electrically connected to the UART/USB converting chip 620 is for transceiving the USB signal S4. The USB connector 630 must be a TYPE A male USB connector while the computer 40 includes a TYPE A female USB connector, but the invention is not limited thereto. Because the current desktop computer and the current notebook computer are equipped with the USB connectors, the electronic apparatus 50 can communicate with the computer 40, which is either the desktop computer or the notebook computer, through the UART/USB converting apparatus 60. The UART/USB converting apparatus 60 may be a UART/USB converting cable.

The UART connector 610 is for transceiving the UART signal S3 ranging from 0 to 3.3 volts but not the RS232 signal S2 with +15 volts or −15 volts (see FIG. 2). Thus, no RS232 voltage converting chip has to be additionally disposed in the electronic apparatus 50, as shown in FIG. 3, so that the manufacturing cost can be greatly decreased, and the difficulty of circuit layout may also be decreased.

FIG. 5 is a schematic illustration showing the UART/USB converting chip 620 and the USB connector 630, which are disposed on a circuit board 640. Referring to FIG. 5, a UART/USB converting apparatus 60a may further include the circuit board 640 and a cable 650 with respective to the UART/USB converting apparatus 60. The UART/USB converting chip 620 and the USB connector 630 are disposed on the circuit board 640. Two ends of the cable 650 are respectively electrically connected to the UART connector 610 and the UART/USB converting chip 620. The length of the cable 650 satisfies the RS232 specification. The UART/USB converting apparatus 60a may be a UART/USB converting cable.

FIG. 6 is a schematic illustration showing the UART connector 610, the UART/USB converting chip 620 and the USB connector 630, all of which are disposed on a circuit board 640a. A UART/USB converting apparatus 60b may further include a circuit board 640a with respective to the UART/USB converting apparatus 60. The UART/USB converting chip 620 and USB connector 630 may be disposed on the circuit board 640 and the UART connector 610 may be electrically connected to the UART/USB converting chip 620 through the cable 650, as shown in FIG. 5. Alternatively, the UART connector 610, the UART/USB converting chip 620 and the USB connector 630 are disposed on the circuit board 640a, as shown in FIG. 6.

Because the UART connector 610, the UART/USB converting chip 620 and the USB connector 630 are disposed on the circuit board 640a, it is possible to etch a copper foil directly on the circuit board 640a to electrically connect the UART connector 610 to the UART/USB converting chip 620, and to electrically connect the UART/USB converting chip 620 to the USB connector 630. Consequently, it is unnecessary to purchase the cable 650 additionally so that the manufacturing cost can be decreased and the product competitiveness can be enhanced.

### Second Embodiment

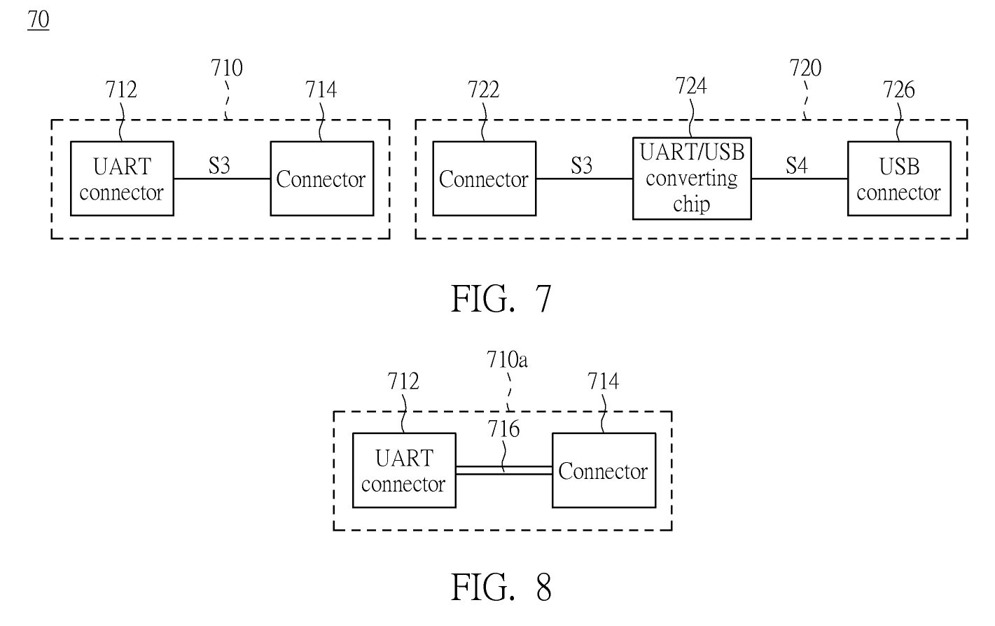

FIG. 7 is a block diagram showing a UART/USB converting apparatus according to the second embodiment of the invention. The UART/USB converting apparatus 80 in the second embodiment is represented by an UART/USB converting apparatus 70. The UART/USB converting apparatus 70 includes an adapter 710 and an adapter 720. The adapters 710 and 720 may be cables.

The adapter 710 includes a UART connector 712 and a connector 714. The UART connector 712 is for transceiving the UART signal S3 ranging from 0 to 3.3 volts, and the connector 714 is electrically connected to the UART connector 712. The UART connector 712 is, for example, a DB9 connector or a RJ-11 connector, and the UART signal S3 preferably ranges from 0 to 3.3 volts. The UART connector 712 is electrically connected to a UART connector in the electronic device 50.

The adapter 720 includes a connector 722, a UART/USB converting chip 724 and a USB connector 726. The connector 722 is electrically connected to the connector 714 of the adapter 710, and the connector 714 and the connector 722 are, for example, TYPE A USB connectors. The connector 714 is a male connector, and the connector 722 is a female connector, but the invention is not limited thereto. The USB connector 726 is electrically connected to a USB connector in the computer 40.

The UART/USB converting chip 724 is electrically connected between the connector 722 and the USB connector 726. The UART/USB converting chip 724 electrically connected to the connector 722 is for converting between the UART signal S3 and the USB signal S4. The USB connector 726 electrically connected to the UART/USB converting chip 724 is for transceiving the USB signal S4. The USB connector 726 must be a TYPE A male connector, while the computer 40 includes a TYPE A female connector, but the invention is not limited thereto. Because the current desktop computer and the current notebook computer are equipped with USB connectors, the electronic apparatus 50 (see FIG. 3) can communicate with the computer 40, which may be either the desktop computer or the notebook computer, through the UART/USB converting apparatus 70.

The UART connector 712 is for transceiving the UART signal S3 ranging from 0 to 3.3 volts but not the RS232 signal S2 with +15 volts or −15 volts, as shown in FIG. 2. Therefore, no RS232 voltage converting chip has to be additionally disposed in the electronic apparatus 50 so that the manufacturing cost can be greatly reduced and the difficulty of circuit layout may also be decreased.

Besides, the adapter 720 may be standardized and mass-produced or mass-purchased, but adapter 710 may be flexibly produced according to the kind of the electronic apparatus 50 or may be constantly purchased. Consequently, the manufacturing cost may further be decreased, and the product competitiveness can be enhanced.

FIG. 8 is a schematic illustration showing the UART connector 712 and the connector 714 coupled together through a cable 716 in an adapter 710a. Referring to FIG. 8, the adapter 710a may further include the cable 716. Two ends of the cable 716 are respectively electrically connected to the UART connector 712 and the connector 714. The length of the cable 716 satisfies the RS232 specification.

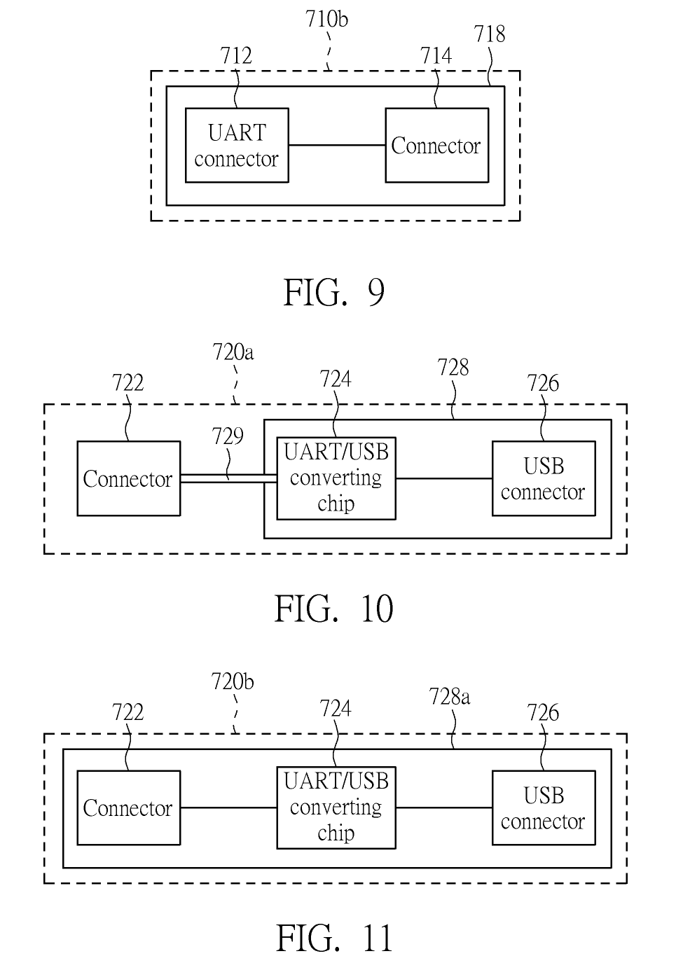

FIG. 9 is a schematic illustration showing the UART connector 712 and the connector 714, which are disposed on a circuit board 718 in an adapter 710b. Referring to FIG. 9, the adapter 710b may further include the circuit board 718, on which the UART connector 712 and the connector 714 are disposed. Because the UART connector 712 and the connector 714 are disposed on the circuit board 718, it is possible to etch a copper foil directly on the circuit board 718 to electrically connect the UART connector 712 to the connector 714. Consequently, it is unnecessary to purchase the cable additionally so that the manufacturing cost can be decreased greatly and the product competitiveness can be enhanced.

FIG. 10 is a schematic illustration showing the UART/USB converting chip 724 and the USB connector 726 disposed on a circuit board 728 in an adapter 720a. Referring to FIG. 10, the adapter 720a may further include the circuit board 728 and a cable 729. The UART/USB converting chip 724 and the USB connector 726 are disposed on the circuit board 728, and two ends of the cable 729 are respectively electrically connected to the connector 722 and the UART/USB converting chip 724. The length of the cable 729 satisfies the RS232 specification.

As shown in FIG. 11, the connector 722, the UART/USB converting chip 724 and the USB connector 726 are disposed on a circuit board 728a in an adapter 720b. The UART/USB converting chip 724 and the USB connector 726 may be disposed on the circuit board 728 and the connector 722 may be electrically connected to the UART/USB converting chip 724 (see FIG. 10) through the cable 729. Alternatively, the connector 722, the UART/USB converting chip 724 and the USB connector 726 are disposed on the circuit board 728a, as shown in FIG. 11.

Because the connector 722, the UART/USB converting chip 724 and the USB connector 726 may be disposed on the circuit board 728a, it is possible to etch a copper foil directly on the circuit board 728a to electrically connect the connector 722 to the UART/USB converting chip 724, and to electrically connect the UART/USB converting chip 724 to the USB connector 726. Consequently, it is unnecessary to additionally purchase the cable 729 so that the manufacturing cost can be greatly decreased, and the product competitiveness can be enhanced.

The UART/USB converting apparatus according to the embodiment of the invention is for transceiving the UART signal ranging from 0 to 3.3 volts but not the RS232 signal with +15 volts or −15 volts. Therefore, it is unnecessary to dispose on the RS232 voltage converting chip additionally in the electronic apparatus. Consequently, the manufacturing cost may be greatly decreased, and the difficulty of circuit layout may also be decreased. Furthermore, the electronic apparatus can communicate with the computer, which is either the desktop computer or the notebook computer, through the USB connector of the UART/USB converting apparatus.

While the invention has been described by way of examples and in terms of preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A universal asynchronous receiver/transmitter (UART)/universal serial bus (USB) converting apparatus, comprising:
a UART connector transceiving a UART signal ranging from 0 to 3.3 volts;
a UART/USB converting chip electrically connected to the UART connector, converting between the UART signal and a USB signal; and
a USB connector electrically connected to the UART/USB converting chip, transceiving the USB signal.

2. The apparatus according to claim 1, wherein the UART signal ranges from 0 to 3.3 volts.

3. The apparatus according to claim 1, further comprising:
a circuit board, on which the UART/USB converting chip and the USB connector are disposed.

4. The apparatus according to claim 1, further comprising:
a circuit board, on which the UART connector, the UART/USB converting chip and the USB connector are disposed.

5. The apparatus according to claim 1, further comprising a cable, which comprises:
a first end electrically connected to the UART connector; and
a second end electrically connected to the UART/USB converting chip.

6. The apparatus according to claim 5, wherein a length of the cable satisfies the RS232 specification.

7. The apparatus according to claim 1, wherein the UART connector is a DB9 connector or a RJ-11 connector.

8. A universal asynchronous receiver/transmitter (UART)/universal serial bus (USB) converting apparatus, comprising:
a first adapter, which comprises:
a UART connector transceiving a UART signal ranging from 0 to 3.3 volts; and
a first connector electrically connected to the UART connector; and
a second adapter, which comprises:
a second connector electrically connected to the first connector;
a UART/USB converting chip electrically connected to the second connector, converting between the UART signal and a USB signal; and
a USB connector electrically connected to the UART/USB converting chip, transceiving the USB signal.

9. The apparatus according to claim 8, wherein the UART signal ranges from 0 to 3.3 volts.

10. The apparatus according to claim 8, further comprising:
a circuit board, on which the UART/USB converting chip and the USB connector are disposed.

11. The apparatus according to claim 8, further comprising:
a circuit board, on which the second connector, the UART/USB converting chip and the USB connector are disposed.

12. The apparatus according to claim 8, further comprising:
a circuit board, on which the first connector and the UART connector are disposed.

13. The apparatus according to claim 8, further comprising a cable, which comprises:
a first end electrically connected to the first connector; and
a second end electrically connected to the UART connector.

14. The apparatus according to claim 13, wherein a length of the cable satisfies an RS232 specification.

15. The apparatus according to claim 13, further comprising an another cable, which comprises:
an another first end electrically connected to the second connector; and
an another second end electrically connected to the UART/USB converting chip.

16. The apparatus according to claim 15, wherein a length of the another cable satisfies the RS232 specification.

17. The apparatus according to claim 8, further comprising a cable, which comprises:
a first end electrically connected to the second connector; and
a second end electrically connected to the UART/USB converting chip.

18. The apparatus according to claim 17, wherein a length of the cable satisfies an RS232 specification.

19. The apparatus according to claim 8, wherein the UART connector is a DB9 connector or a RJ-11 connector.

20. The apparatus according to claim 8, wherein the first and second connectors are other two USB connectors.
